(19) United States
(12) Patent Application Publication
(10) Pub. No.: US 2005/0198362 A1
(43) Pub. Date: Sep. 8, 2005

(54) Exception packet forwarding

(76) Inventors: Muraleedhara Herur Navada, Santa Clara, CA (US); Hitesh Rastogi, San Jose, CA (US)

Correspondence Address: FISH & RICHARDSON, PC, 12390 EL CAMINO REAL, SAN DIEGO, CA, 92130-2081, US

(21) Appl. No.: 10/750,554

(22) Filed: Dec. 31, 2003

(51) Int. Cl. G06F 15/16

(52) U.S. Cl. 709/236

(57) ABSTRACT

A method includes inserting a vector in a packet that identifies a first device in a stack of packet forwarding devices that delivers the packet to an exception processor being shared by the packet forwarding devices in the stack.

### BACKGROUND

Network switches, routers, and the like are used to distribute information through networks by sending the information in segments such as packets. A packet typically includes a “header” that stores a destination address for routing the packet and a “payload” that stores a segment of the information being sent through the network. For forwarding packets to intended destinations, some networks include a group of routers that appears as a single large router, known as a stack, to network devices external to the stack. By grouping the routers into a stack, an aggregate of the router ports is produced and various administrative functions and operational rules are shared among the routers in the stack for routing packets to their intended destinations.

### DESCRIPTION OF DRAWINGS

FIG. 1 is a block diagram depicting a system for forwarding packets.

FIG. 2 depicts a packet.

FIG. 3 is a block diagram depicting a stack of routers.

FIG. 4 is a block diagram depicting a router.

FIG. 5 depicts tables for routing packets through a stack.

FIG. 6 is a flow chart of a portion of a packet classifier.

FIG. 7 is a flow chart of a portion of an exception packet manager.

FIG. 8 is a flow chart of a portion of a packet forwarder.

### DESCRIPTION

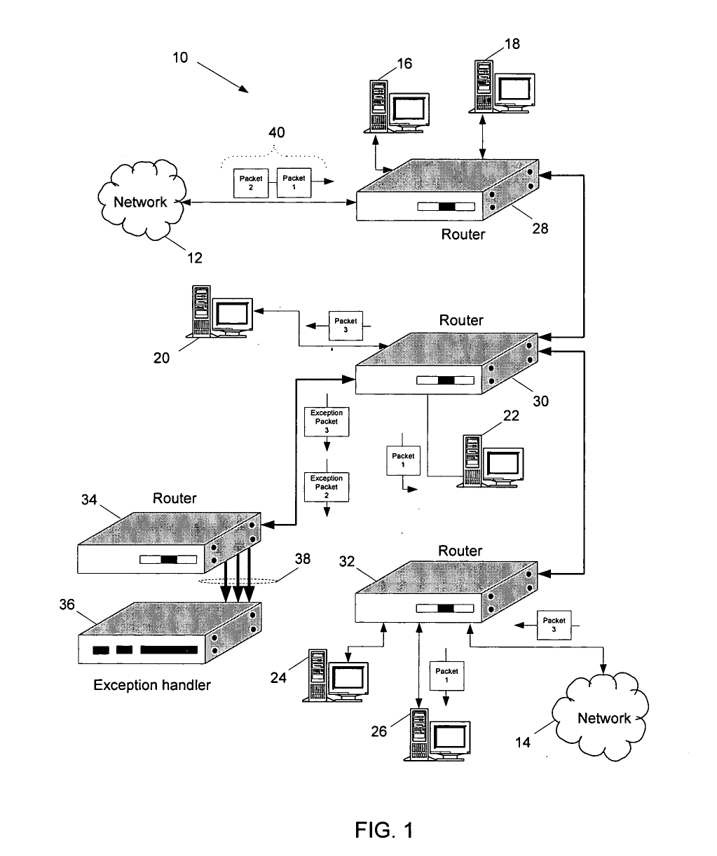

Referring to FIG. 1, a system 10 for transmitting packets among networks 12, 14 (e.g., local area networks (LANs), wide area networks (WANs), the Internet, etc.) and computer systems 16-26 includes four routers 28-34 that are connected to produce a stack of routers. In one example, three of the routers 28, 30, 32 are each located on separate floors of a building and deliver packets to the computer systems respectively connected to the router. For example, router 28 may be located on the top floor of a building and deliver packets to computer systems 16, 18 that are located on the floor. In this arrangement routers are used to produce the stack and to deliver packets, however in other arrangements system 10 includes a stack of network switches, hubs, or other packet forwarding devices. Furthermore, the stack may include a combination of different types of packet forwarding devices. For example, a stack produced with a combination of network switches and routers may be included in system 10.

When a packet enters the stack of routers from either network 12, 14, or from one of the computer systems 16-26, or other device (e.g., a server, a personal digital assistant (PDA), etc.) in communication with the stack, the recipient router identifies the intended destination of the packet and directs the packet through the stack for delivery. However, periodically the recipient router is unable to identify the intended destination of the packet. For example, an intended destination address of a packet is not known by the recipient router, or the packet's header may not be storing the intended destination address. In another example, a received packet is corrupted during transmission and the intended packet destination cannot be identified.

If the intended packet destination is not identified, an exception packet is produced by the recipient router and is sent to an exception handler 36 that is in communication with the stack. In some arrangements, an exception packet includes data that identifies the basis for producing the exception packet. For example, the exception packet includes a code indicating an unidentified destination or that the received packet uses a particular protocol that needs to be changed by exception handler 36. In another example, exception packets are produced for exception handler 36 to provide data to devices in the stack. For example, a protocol packet enters the stack that stores addresses of devices recently added to network 12. An exception packet is produced by the recipient stack device and is sent to exception handler 36 for processing and distributing these addresses to the devices in the stack. Also, data in the exception packet may indicate that the received packet includes protocol control data to send to the exception handler 36 for establishing and configuring network-layer protocols used by devices in the stack or outside the stack. Typically, exception packets also include data that assign a priority to each packet for use in processing by exception handler 36.

To send exception packets to exception handler 36, router 34 is dedicated to receiving exception packets from routers 28, 30, and 32 and transferring them to the exception handler. However, in some arrangements, router 34 also connects to other devices (e.g., computer systems) external to the stack for sending and receiving packets. Since all exception packets produced by routers 28-32 are sent to router 34 for delivery to exception handler 36, multiple transmission lines 38 (e.g., Ethernet lines, etc.) connect router 34 and exception handler 36 to provide the appropriate bandwidth for sending the exception packet traffic from the routers in the stack. By using a centralized exception handler 36, each router included in the stack does not need to include or support a dedicated exception handler. Furthermore, to process the exception packets, the centralized exception handler 36 includes one or more exception processors that execute processes using the received exception packets. By using a single, centralized exception handler 36 in system 10, the number of exception handlers needed for processing exception packets is reduced along with the hardware, software, and associated costs in comparison to assigning a dedicated exception handler to each router in the stack.

In this particular example, a packet stream 40 that includes two packets (e.g., packet_{—}1 and packet_{—}2) is received by the stack through router 28 from network 12. Similarly, a packet_{—}3 is received by the stack through router 32 from network 14. Once received, the individual packets are checked for exceptions and are delivered to their intended destination(s) as provided by header data in each packet. For example, router 28 determines that packet_{—}1 is not associated with an exception and its header includes data representing that the packet is destined for computer systems 22 and 26. Similarly, packet_{—}2 and packet_{—}3 are respectively checked by recipient routers 28 and 32. However, packet_{—}2 and packet_{—}3 are associated with exceptions (e.g., unidentified destinations, are protocol control packets, etc.). Routers 28 and 32 respectively produce and send exception_packet_{—}2 and exception_packet_{—}3 to router 34 for delivery to exception handler 36. Also, a copy of packet_{—}3 is sent to computer system 20, for example, if packet_{—}3 includes control protocol data needed by computer system 20. Upon receiving exception_packet_{—}2 and exception_packet_{—}3, the exception handler 36 processes the packets, based on each packet's priority, and may send the processed packets back to the stack for delivery to one or more intended destinations (e.g., computer system 24, network 14, etc.).

Along with passing exception packets, the stack passes packets and copies of packets to the computer systems and the networks in system 10, based on their intended destination(s). For example, to deliver packet_{—}1 to computer system 22, the packet is passed from router 28 to router 30 and then a copy of the packet is delivered to computer system 22. Also, since packet_{—}1 is intended for delivery to computer system 26, a copy of the packet is sent from router 30 to router 32 that exits the stack for delivery to computer system 26.

Also, in some arrangements an exception packet is produced for sending through the stack when a received packet's intended destination is known. For example, the intended destination of a received packet is determined and the packet is sent through the stack to the destination. However, an exception packet is also produced and is sent to exception handler 36 for bookkeeping, or statistics collecting, or other similar processing known as “snooping”.

As each of the packets (e.g., packet_{—}1, packet_{—}2, packet_{—}3) enter the stack by being received by respective routers 28 and 32, each packet is directed through the routers in the stack by data referred to as a “device vector”, which is inserted into the header of the packet. The device vector is used by each router to determine the appropriate router port or ports to use to efficiently send the packet through the stack. By inserting a device vector in each packet that enters the stack, packet processing time is reduced since each router does not need to individually determine the destination(s) of each packet being passed about the stack. By reducing processing time, conserved clock cycles can be used for other router operations such as determining if a packet is associated with an exception.

Similar to packet_{—}1, received packet_{—}2 is examined by router 28 for intended destinations. However, router 28 determined that packet_{—}2 is associated with an exception (e.g., unidentified packet destination) and produced exception_packet_{—}2. Similar to packet_{—}1, the header of exception_packet_{—}2 is inserted with a device vector for directing the exception packet to router 34 for delivery to exception handler 36. Similarly, received packet_{—}3 is examined by router 32 and is determined to include control protocol data that needs to be delivered to exception handler 36 and computer 20. To send packet_{—}3 to computer system 20, a copy of packet_{—}3 is inserted with a device vector to direct the packet to router 30 for delivery to computer system 20. To direct packet_{—}3 to exception handler 36, router 32 produced exception_packet_{—}3 that is inserted with a device vector for routing the exception packet to router 34 for delivery to exception handler 36.

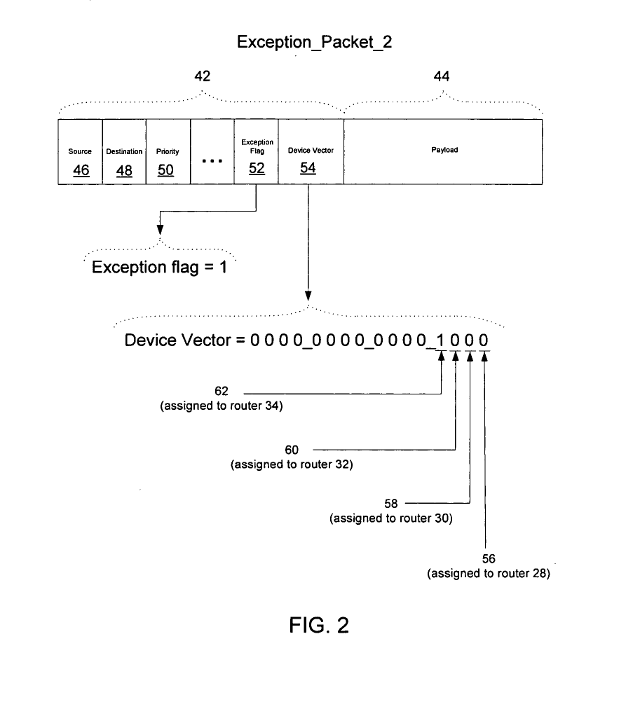

Referring to FIG. 2, exception_packet_{—}2 or other packets (e.g., packet_{—}1, exception_packet_{—}3, etc.) sent through the stack of routers includes a header 42 and a payload 44. Header 42 includes data for directing the packet to intended destinations and through the stack while payload 44 stores the particular data being sent by the packet. In this example, header 42 includes a segment 46 that stores data that represents the source (e.g., network 12) of exception_packet_{—}2 and another segment 48 that stores data representing the one or more intended destinations (e.g., computer system 16, network 14, etc.) of exception_packet_{—}2. Header 42 also includes a segment 50 that stores data representing a priority that is assigned for delivering exception_packet_{—}2. For example, data representing a higher priority identifies that exception_packet_{—}2 be delivered before a packet assigned a lower priority. Header 42 also includes a segment 52 that stores a binary number that identifies whether or not exception_packet_{—}2 is an exception packet. For example, segment 52 includes a binary number that stores logic “1” to indicate exception_packet_{—}2 is an exception packet or a logic “0” to indicate the packet is not an exception packet. In this particular example, since packet_{—}2 was determined to be associated with an exception, logic “1” is stored in segment 52.

Header 42 also includes a device vector 54 that is inserted in exception_packet_{—}2 by the ingress stack device (e.g., router 28) that received the packet from outside the stack. The device vector is an entry that includes data to identify which router or routers in the stack need to receive the packet. To identify the particular router or packet-forwarding device in the stack that needs to receive exception_packet_{—}2 for delivering the packet to its intended destination, the inserted device vector 54 includes bits that are individually assigned to the routers 28-34 in the stack. For example, device vector 54 includes sixteen bits, in groups of four, to represent sixteen routers or other packet forwarding devices included in the stack. Here, least significant bit 56 in device vector 54 indicates whether exception_packet_{—}2 needs to be sent to router 28 and bit 58 indicates whether the packet needs to be sent to router 30. Progressing through the bits, bit 60 represents if exception_packet_{—}2 needs to be sent to router 32 and bit 62 represents if the packet needs to be sent to router 34. In this example, since exception flag 52 indicates the packet is an exception packet, bit 62 is set to logic “1” so that the packet is sent to router 34 for delivering to exception handler 36. However, in some arrangements bit 62 may also be set to logic “1” so that the packet is sent to router 34 for delivering to a computer system or other device external to the stack and connected to router 34.

Since the stack in system 10 includes four routers, four bits 56-62 are used to assign a bit to each router. However, since device vector 54 includes sixteen bits, the remaining twelve bits can be used in other arrangements for assigning to additional packet forwarding devices included in the stack. Also, while device vector 54 includes sixteen bits, in other arrangements the device vector includes more or less bits.

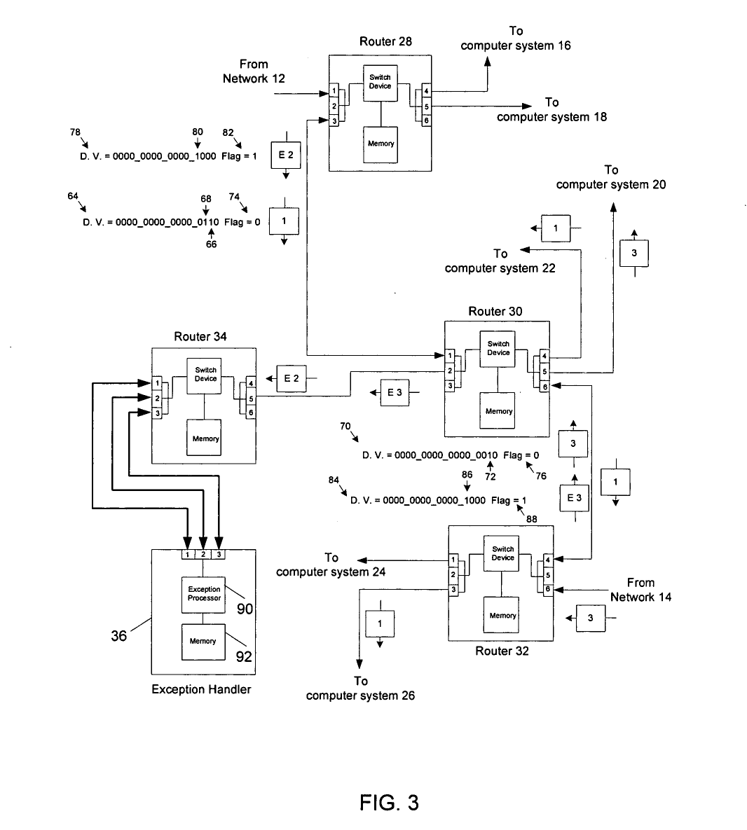

Referring to FIG. 3, each of the routers 28-34 in the stack respectively includes six ports (e.g., ports 1-6) that allow bi-directional packet transferring among the routers. For example, port 3 in router 28 connects to port 1 in router 30 for transferring packets. Similarly, port 6 in router 30 connects to port 4 in router 32 for transferring packets in either direction. Also, port 2 in router 30 connects to port 5 in router 34. Since exception packets from each of the routers 28-32 are sent to router 34 for delivery to exception handler 36, three ports (e.g., ports 1, 2, and 3) in router 34 connect to three ports (e.g., ports 1, 2, and 3) in the exception handler. By connecting router 34 and exception handler 36 with multiple transmission lines, the appropriate bandwidth is provided to handle the combined exception packet traffic from each router.

Also, particular ports in the routers 28-32 respectively connect to computer systems 16-26 and networks 12, 14 external to the stack. For example, port 4 in router 28 connects to computer system 16 and port 5 connects to computer system 18. Similarly, port 1 in router 28 connects to network 12 for bi-directional packet transfer. While this example provides six ports in each router 28-34 for transferring packets, in other arrangements, each of the routers 28-34 includes more than six ports (e.g., 24 ports, 48 ports, etc.) so that the port aggregate of the stack is larger (e.g., 96 ports, 192 ports, etc.) compared to the twenty-four port aggregate produced by the four six-port routers. Although, one or more of the routers 28-34 may include less than six ports. Also, while this stack includes four routers 28-34, in other arrangements, more or less routers or other types of packet forwarding devices are connected to produce a stack and deliver packets. Also, in some arrangements, the stack of packet forwarding devices is implemented on a smaller scale. For example, the stack of packet forwarding devices is implemented in a processor (e.g., a microprocessor, packet processor, etc.) or in a group of processors.

Each of the routers 28-34 in the stack is capable of inserting a device vector into the header of a packet being routed through the stack. Typically, the device vector is inserted by the first router or other type of packet forwarding device (e.g., network switch, hub, etc.) to first receive the packet into the stack. For example, since packet_{—}1 and packet_{—}2 are received in the stack by router 28, router 28 inserts device vectors into each of the packets. Similarly, router 32 inserts a device vector in packet_{—}3 since the stack ingress point for the packet from network 14 is router 32.

Since device vectors are used for directing packets among the routers 28-34 included in the stack, each device vector is typically removed from the packet when the packet exits the stack. For example, prior to packet_{—}1 being sent through port 4 to computer system 22, router 30 removes the device vector from the packet. Similarly, prior to sending a packet through port 6 to network 14, router 32 removes any device header inserted in packet.

Once a device vector is inserted in a packet, as the routers 28-34 in that stack receive the packet, the device vector is used to direct the packet through the stack for delivery to its intended destination outside of the stack. For example, since the intended destination of packet_{—}1 is computer system 22, the packet needs to be delivered from router 28 to router 30 for delivery to computer system 22. Also, since packet_{—}1 is destined for computer system 26, a copy of the packet needs to be transferred from router 30 to router 32 for delivery to computer system 26. So, to deliver packet_{—}1 to both computer systems 22, 26, router 28 inserts a device vector 64 in packet_{—}1 that identifies both router 30 and 32 by storing a logic “1” in the bits 66, 68 respectively assigned to router 30 and 32. Similarly, router 32 inserts a device vector 70 in a copy of packet_{—}3 that stores a logic “1” in bit 72 respectively assigned to router 30. Also, since packet_{—}1 and this copy of packet_{—}3 are not exception packets, respective exception flags 74, 76 store logic “0”.

After packet_{—}2 is received by router 28, the router determines that packet_{—}2 is associated with an exception and needs to be sent to exception handler 36. To direct packet_{—}2 through the stack to exception handler 36, router 28 produces exception_packet_{—}2 that is labeled “E 2” in FIG. 3. Router 28 also inserts a device vector 78 in exception_packet_{—}2 that identifies router 34 as the destination of the packet by storing a logic “1” in the respective device vector bit 80 assigned to router 34. Also, to identify exception_packet_{—}2 as an exception packet, a logic “1” is stored in exception flag 82 included in the packet header. Once device vector 78 and exception flag 82 are inserted into exception_packet_{—}2, the packet is sent out port 3 of router 28 to router 30. By examining the inserted device vector, router 30 determines that exception_packet_{—}2 is intended for router 34 and sends the packet through port 2 to port 5 in router 34. Router 34 determines which of the three ports (e.g., port 1, 2, or 3) to use to send exception_packet_{—}2 to exception handler 36.

Similar to packet_{—}2, router 32 determines that received packet_{—}3 is associated with an exception and produces an exception_packet_{—}3, labeled in FIG. 3 as “E 3”, which needs to be sent to exception handler 36 for processing. To direct exception_packet_{—}3 through the stack and to exception handler 36, router 32 inserts a device vector 84 in exception_packet_{—}3 that stores a logic “1” in bit 86, which is assigned to identify router 34. Also, to identify exception_packet_{—}3 as an exception packet, a logic “1” is stored in an exception flag 88 that is inserted in exception_packet_{—}3. Once device vector 84 and the exception flag 88 are stored in exception_packet_{—}3, the packet is sent through port 4 of router 32 to router 30. After receiving exception_packet_{—}3, router 30 determines from device vector 84 that the packet is destined for router 34 and sends it through port 2 to router 34. After receiving exception_packet_{—}3, router 34 determines which one of its ports 1, 2, or 3 to send the packet for processing by an exception processor 90, for example an Intel® IXP 2800 Network Processor, which is included in exception handler 36. Also, the exception handler 36 typically includes a memory 92 that stores packets prior to their processing by exception processor 90.

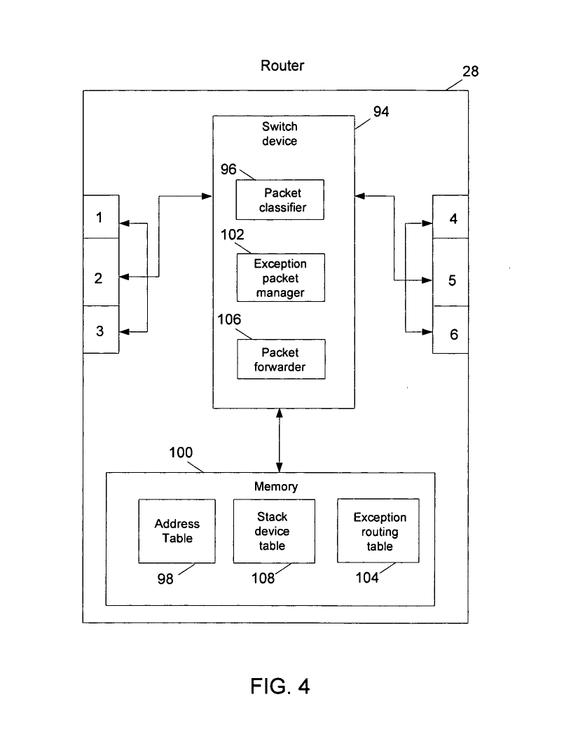

Referring to FIG. 4, router 28, similar to routers 30-34, includes six ports for sending and receiving packets, however, in other arrangements the router includes more (e.g., twenty-four ports) or less ports. As packets are received by router 28, the packets are passed to a switch device 94, for example an Intel® IXE 7424 Media Switch Device, which determines the intended destination of the packets and the appropriate port(s) to send each packet. For example, both packet_{—}1 and packet_{—}2, which are received on port 1 (shown in FIG. 2) from network 12 and are sent through port 3 to router 30.

A packet classifier 96 executed in switch device 94 determines a packet's destination if the packet is received from a device (e.g., network 12, computer system 16, etc.) external to the stack. To determine a packet destination, packet classifier 96 accesses data stored in the header of the packet and compares it to data stored in an address table 98 that is stored in a memory 100 (e.g., random access memory (RAM), static RAM (SRAM), dynamic RAM (DRAM), read-only memory (ROM), etc.) included in router 28. Also, packets are received from devices external to the stack that do not include device vectors for directing the packets among the routers 28-34 in the stack. Packet classifier 96 produces and inserts a device vector in the appropriate packets so that each of the routers 28-34 can determine the next router or routers to send the respective packets to. Alternatively, if a packet has already entered the stack and is received from one of the other routers (e.g., router 30, etc.) or another stack device, router 28 accesses the device vector stored in the packet to determine the next, if any, router in the stack to send the packet or a copy of the packet. In this example, to determine if a packet is received from a device (e.g., a router) in the stack or a device (e.g., computer system) external the stack, each router in the stack tracks whether its individual ports are connected to devices internal or external to the stack. For example, router 28 tracks that ports 1, 4, and 5 are connected to devices (e.g., network 12, computer system 16, computer system 18) external to the stack while port 3 is connected to a stack device (e.g., router 30).

In this arrangement packet classifier 96 also determines if a received packet is associated with an exception. For example, if the packet is received from another device in the stack (e.g., router 30), packet classifier 96 accesses the packet header to determine if the exception flag identifies the packet as an exception packet (e.g., logic “1” stored in the exception flag). Also, as packets are received from devices external to the stack that do not include an exception flag, packet classifier 96 detects if the received packet is associated with an exception. For example, if packet classifier 96 cannot determine the intended destination of a packet or if the packet was corrupted during transmission, packet classifier 96 identifies the packet as an exception packet.

If the received packet is an exception packet, as provided by an inserted exception flag, or is detected to be associated with an exception, the packet is sent to an exception packet manager 102 that stores a logic “1” in the exception flag of the packet, if not already stored, to identify the packet as an exception packet. Also, to direct the exception packet to exception handler 36, exception packet manager 102 accesses data in an exception routing table 104 stored in memory 100. Exception routing table 104 stores data that identifies the particular router in the stack that is connected to exception handler 36. In this particular example, the exception routing table 104 includes data to route exception packets to router 34 for delivery to exception handler 36. Also, in this example exception routing information is stored in table 104, however, in other arrangements the data is stored in a register or other type of memory.

Along with sending packets to exception handler 36, packets may also be sent to other routers 30-32 in the stack for delivery to intended destinations (e.g., computer system 22, network 14, etc.). Also, in some arrangements, packets are sent to router 34 for delivering to devices (e.g. computer systems, etc.) connected to the router and external to the stack. To determine the router or routers to send a packet, a packet forwarder 106 executed by the switch device 94 accesses the device vector inserted in the packet and identifies which bits in the device vector are set to logic “1”. For example, device vector 64 in packet_{—}1 includes bit 66 that identifies router 30 and is set to logic “1”. After identifying that bit 66 is set to logic “1”, packet forwarder 106 accesses a stack device table 108 stored in memory 100, to determine the particular port or ports in router 28 to send the packet. In this example, switch device 94 uses stack device table 108 to determine that packet_{—}1 be sent through port 3 for delivering the packet to router 30. Additionally, the stack device table 108 includes data that identifies which port in router 28 to send exception packets over for routing to exception handler 36. Furthermore, by storing data in the exception routing table 104 to identify the stack device (e.g., router 34) connected to exception handler 36, if the exception handler is moved and connected to another stack device, only data in the exception routing table 104 needs to be altered and not data in the stack device table 108.

Prior to sending a packet, packet forwarder 106 also changes device vector data stored in the packet to reflect that the packet is being sent to another router in the stack or to a device (e.g., computer system 22, network 14, etc.) external to the stack. For example, upon receiving packet_{—}1, packet classifier 96 sets bits 66 and 68 in device vector 64 to logic “1” so that a copy of the packet is sent to routers 30 and 32. However, after packet_{—}1 is received by router 30, the device vector stored in the copy of packet_{—}1 sent to router 32 only has bit 68, set to logic “1” which identifies router 32 since the packet has already been delivered to router 30. By changing the logic stored in the device vector bits as a packet propagates through the stack, the device vector identifies the next stack device or stack devices to receive the packet.

Packet classifier 96, exception packet manager 102, and packet forwarder 106 executed on switch device 94 are typically stored in memory 100. However, in other arrangements either one or more of the packet classifier 96, the exception packet manager 102, or the packet forwarder 106 are stored in a storage device (e.g., a hard drive, CD-ROM, etc.) in communication with the switch device 94. Also, in this example memory 100 is presented separate from the switch device 94. However, in other arrangements memory 100 is included in switch device 94.

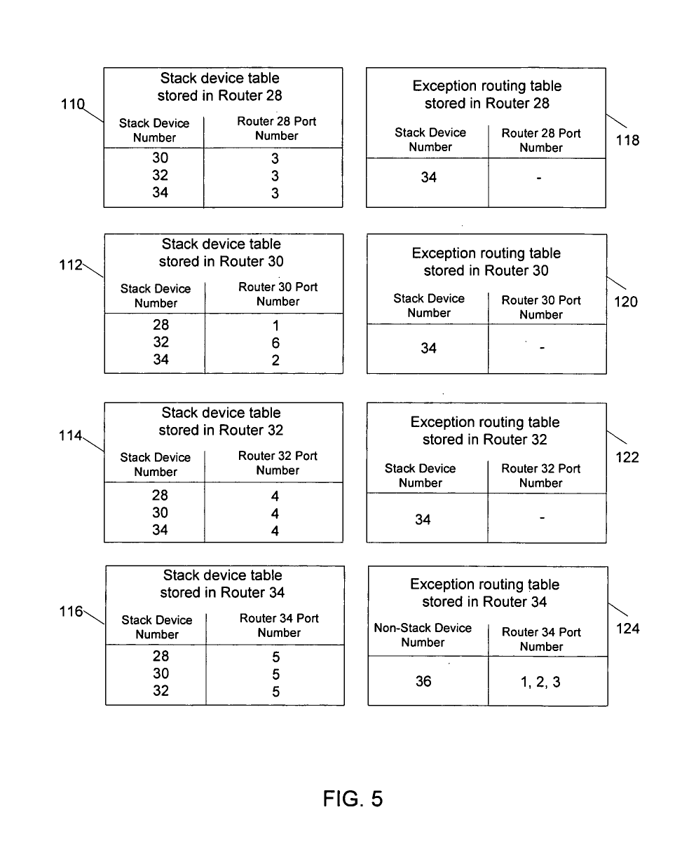

Referring to FIG. 5, stack device tables 110-116 respectively stored in routers 28, 30, 32, and 34 include data for matching a destination router to the particular port for sending a packet. For example, stack device table 110, which is stored in router 28, identifies the port in router 28 for sending packets to routers 30, 32, and 34. Packets sent through port 3 in router 28 are delivered to router 30, and from router 30 can be sent to router 32 or router 34. Similarly, stack device table 112, which is stored in router 30, is used to determine the particular port in router 30 to use to send packets to routers 28, 32, and 34. In particular, packets are delivered to router 28 by sending the packets through port 1 and packets are delivered to router 32 by sending the packets through port 6 in router 30. Furthermore, packets such as exception packets are sent through port 2 to router 34 for delivery to exception handler 36. Also, stack device table 114, which is stored in router 32, is used to determine the particular port in router 32 to use to send packets to routers 28, 30, and 34. In particular, packets to be delivered to either router 28, 30, or 34 are sent through port 4 of router 32. Similarly, stack device table 116 stores data so that packets sent from router 34, where stack device table 116 is stored, over port 5 to be received by router 28, 30, or 32.

Each of the routers 28-34 in the stack also store respective exception routing tables 118-124 that include the particular router (e.g., router 34) in the stack that connects to exception handler 36 which is external to the stack. So, router 28 stores and uses exception routing table 118 to determine that router 34 is the stack device connected to exception handler 36 for routing exception packets. Also, exception routing table 118 does not provide a port of router 28 for sending exception packets since stack device table 110 provides the particular port (e.g., port 3) for sending packets to router 34. Similarly, exception routing tables 120 and 122, which are respectively stored in routers 30 and 32, both identify router 34 as the stack device connected to exception handler 36 and neither provide appropriate port identifications since the respective stack device tables 112, 114 are used to provide the respective ports (e.g., port 2, port 4) for sending packets to router 34. Exception routing table 124 is stored in router 34 and in this example, provides that router 34 is the stack device dedicated to delivering packets to exception handler 36. After receiving exception packets, router 34 uses the exception routing table 124 to determine which one or more of the multiple ports 1, 2, and 3 to use to transfer the exception packets to exception handler 36 and to provide the bandwidth for handling exception packet traffic from routers 28-34.

To direct exception packets to exception handler 36, the device vector inserted in the exception packet is accessed by the packet forwarder executed in the recipient router to determine which bits are set to logic “1” and uses the locally stored exception routing table stack to determine which stack device (e.g., router 34) is dedicated to sending exception packets to exception handler 36. Then, the locally stored stack device table is accessed to determine the particular port or ports to send the packet or copies of the packet. For example, when exception_packet_{—}2 (shown in FIG. 3 and labeled “E 2”) is received by router 30, the exception packet manager executed in router 30 accesses the exception routing table 120 and determines that exception_packet_{—}2 is to be sent to router 34 for delivering to exception handler 36. The packet forwarder executed on router 30 determines from stack device table 112 that the exception_packet_{—}2 is to be sent over port 2 for routing to router 34.

Similarly, the packet forwarder executed in the recipient router also accesses a device vector of a packet to determine which bits are set to logic “1” and then uses the stack device table stored in the router to determine the particular port or ports to send the packet or copies of the packet. For example, when packet_{—}1 is received by router 28, packet forwarder 106 accesses stack device table 110 and determines that packet_{—}1 is to be placed on port 3 for sending to router 30. Typically, each of the stack device tables 110-116 and the exception routing tables 118-124 are respectively stored in memory included in each router such as stack device table 110 is stored in memory 100 of router 28. However, in some arrangements the stack device tables 110-116 and the exception routing tables 118-124 are stored in one or more storage devices (e.g., hard drives, CD-ROMs, etc.) that are in communication with the respective routers 28-34.

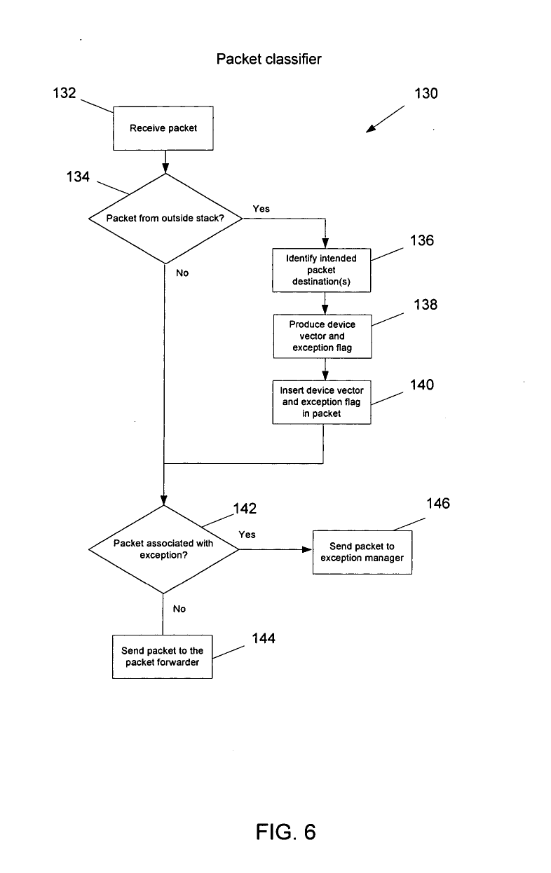

Referring to FIG. 6, a packet classifier 130 such as packet classifier 96 executed in switch device 94, includes 132 receiving a packet. Typically, the packet is received from a device (e.g., router 30, etc.) in a stack or from a source not included in the stack (e.g., network 12, computer system 16, etc.). After receiving the packet, the packet classifier 130 determines 134 if the packet is received from a source outside the stack. If the packet is received from a source external to the stack, the packet classifier 130 identifies 136 the intended destination(s) of the packet. Typically, to identify the intended destination(s), the packet classifier 130 accesses the header data stored in the packet and uses the data with data stored in an address table to identify one or more devices (e.g., router 30, router 32, etc.) in the stack to which the packet needs to be sent for delivering the packet to one or more intended destinations external to the stack (e.g., computer system 22, network 14, etc.)

The packet classifier 130 also includes producing 138 a device vector, such as device vector 54 (shown in FIG. 2), so that one or more stack devices use the device vector to determine the next stack device or devices to receive the packet or a copy of the packet. Also an exception flag is produced to indicate if the packet received from the outside the stack is associated with an exception. In one example, the produced device vector includes a group of bits in which each bit is assigned to a device in the stack and stores a logic “1” for representing that the assigned stack device is an intended destination of the packet or stores a logic “0” to represent that the packet is not intended for delivery to the assigned stack device. Similarly, the produced exception flag includes a bit that stores a logic “1” to indicate that the packet is associated with an exception or a logic “0” to indicate that there is no associated exception. After the device vector and exception flag are produced, the packet classifier 130 inserts 140 the produced device vector and exception flag in the packet.

After the device vector and exception flag are inserted, or if the packet is received from a device (e.g., router 30, etc.) in the stack and has a device vector and a exception flag previously inserted in the packet, the packet classifier 130 determines 142 if the packet is associated with an exception. For example, the packet classifier 130 access the exception flag in the packet to check if a logic “1” is stored. In another example, the packet classifier 130 checks the packet for an unidentified destination or other detectable exception. If the packet is not associated with an exception, the packet classifier 130 sends 144 the packet to a packet forwarder for sending the packet to its intended destination(s). If the packet is associated with one or more exceptions the packet classifier 130 sends 146 the packet to an exception packet manager.

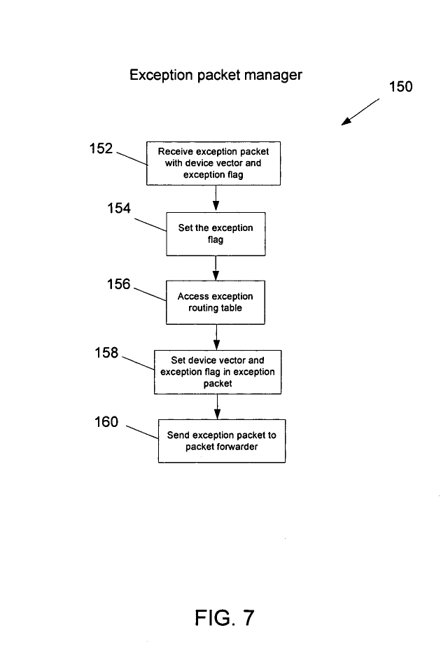

Referring to FIG. 7, an exception packet manager 150, such as exception packet manager 102 executed in router 28, includes receiving 152 a packet with an inserted device vector and exception flag that is associated with one or more exceptions. Once received, the exception packet manager 150 sets 154 the exception flag in the packet, for example, by storing a logic “1” in the flag. Although in some arrangements the exception flag may have been previously set to store logic “1” by another stack device (e.g., router, network switch, etc.) and the exception packet manager does not need to set the exception flag. The exception packet manager 150 also includes accessing 156 an exception routing table, such as exception routing table 104 (shown in FIG. 4) to determine the destination of the exception packet. For example, by accessing exception routing table 118 (shown in FIG. 5) the exception packet manager 150 determines that the exception packet should be sent to router 34 for delivery to exception handler 36. Although, in another example, exception packet manager 150 is executed in the stack device (e.g., router 34) connected to the centralized exception handler (e.g., exception handler 36) and accesses an exception routing table (e.g., exception routing table 124) to retrieve the identification of the exception handler (e.g., exception handler 36).

After determining the destination of the exception packet from data accessed from the exception routing table, the exception packet manager 150 uses the data accessed from the exception routing table to set 158 the device vector in the exception packet so that the packet is directed through the stack to the stack device (e.g., router 34) that sends the exception packets out of the stack to the exception handler shared by the stack devices. Once produced and ready for transmitting, the exception packet manager 150 sends 160 the exception packet to a packet forwarder for sending the exception packet to the destination provided by the exception routing table and other intended destinations, if any, other than the exception handler.

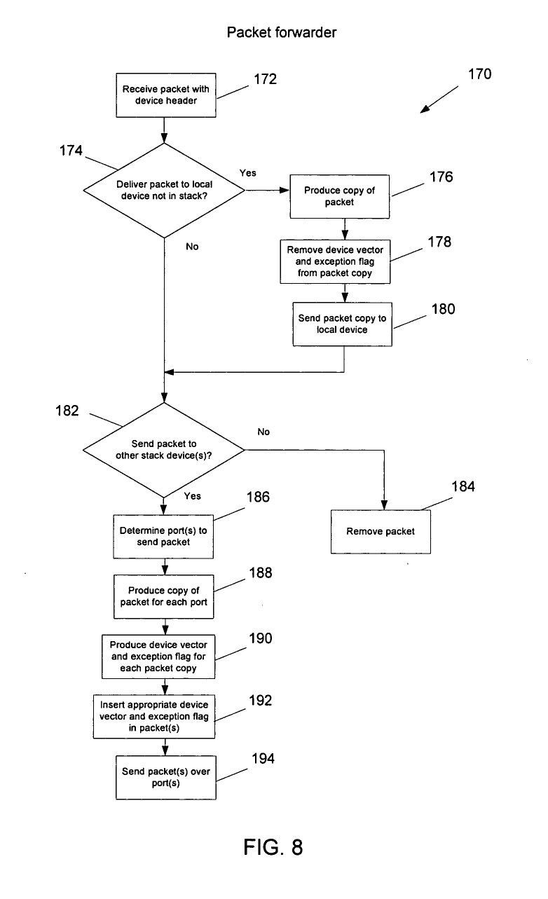

Referring to FIG. 8, a packet forwarder 170, such as packet forwarder 106 executed in router 28, includes receiving 172 a packet (e.g., an exception packet) with a device vector. Typically the packet is received from a packet classifier such as packet classifier 96 executed in the router 28 or an exception packet manager such as exception packet manager 102 that is also executed in router 28. After the packet is received, the packet forwarder 170 determines 174 if the packet is intended for delivery to a computer system or other device (e.g., exception handler 36) that is not included in the stack but is connected to a port of the stack device (e.g., router 28) in which the packet forwarder 170 is executed. For example, the computer systems 16 and 18 (shown in FIG. 2) are external to the stack of the routers 28-34 but are connected to ports in router 28.

To determine if the received packet is intended for a computer system connected to the stack device in which the packet forwarder 170 is executed, the packet forwarder determines if the device vector bit assigned to the stack device is set for a logic “1”. If the packet is intended for a computer system connected to the stack device in which the packet forwarder is executed, the packet forwarder 170 produces 176 a copy of the packet and removes 178 the device vector, and any exception flag, from the copy of the packet. Since the packet is delivered to a computer system or other type of destination outside of the stack, the device vector and exception flag is no longer needed, so they are removed so as not to cause problems at the delivery destination. After removing the device vector, the packet forwarder 170 sends 180 the copy of the packet to the computer system or other destination (e.g., network 12) outside the stack.

If the received packet is not intended for a computer system connected to the stack device in which the packet forwarder 170 is executed or once a copy of the packet is delivered to the local device external to the stack, the packet forwarder 170 determines 182 if the packet is to be sent to one or more other stack devices such as other routers, network switches, or other types of devices in the stack. Typically, to determine if the packet is to be sent to another stack device, the packet forwarder 170 accesses the device vector stored in the packet and checks if any bits associated with other stack devices are set to logic “1”. If the packet is not being sent to one or more other stack devices, the packet forwarder 170 removes 184 the packet from the stack device and reclaims the memory space used to store the packet.

If the packet is to be delivered to one or more other devices (e.g., routers) in the stack, the packet forwarder 170 determines 186 the particular ports of the stack device to send the packet. In some arrangements, the packet forwarder 170 uses a stack device table, such as stack device table 108 (shown in FIG. 4) to determine the one or more ports. If the packet is to be sent over more than one port, the packet forwarder 170 produces 188 a copy of the packet for each port. The packet forwarder 170 also produces 190 device vectors and exception flags for each appropriate packet copy so that each packet is directed through the stack devices to their intended destinations. After producing the device vector or vectors, the packet forwarder 170 inserts 192 the device vectors and exception flags in the appropriate packets and sends 194 the packet(s) through the determined port(s) to the appropriate stack device or devices.

Particular embodiments have been described, however other embodiments are within the scope of the following claims. For example, the operations of packet classifier 130, exception packet manager 150, or packet forwarder 170 can be performed in a different order and still achieve desirable results.

1. A method comprising:
inserting a vector in a packet that identifies a first device in a stack of packet forwarding devices that delivers the packet to an exception processor being shared by the packet forwarding devices in the stack.

2. The method of claim 1 further comprising:
inserting a flag in the packet that indicates the packet is associated with an exception.

3. The method of claim 1 further comprising:
using the vector and a table to determine a port for sending the packet to the first device in the stack of packet forwarding devices.

4. The method of claim 1 wherein the vector includes a bit identifying the first device in the stack of packet forwarding devices.

5. The method of claim 1 further comprising:
removing the vector from the packet for delivering the packet to the exception processor shared by the packet forwarding devices in the stack.

6. The method of claim 1 wherein the packet is delivered over a transmission line in an aggregate of transmission lines to the exception processor shared by the packet forwarding devices in the stack.

7. The method of claim 1 wherein the vector includes bits respectively identifying the packet forwarding devices in the stack.

8. A computer program product, tangibly embodied in an information carrier, the computer program product being operable to cause a machine to:
insert a vector in a packet that identifies a first device in a stack of packet forwarding devices that delivers the packet to an exception processor being shared by the packet forwarding devices in the stack.

9. The computer program product of claim 8 being further operable to cause a machine to:
insert a flag in the packet that indicates the packet is associated with an exception.

10. The computer program product of claim 8 being further operable to cause a machine to:
use the vector and a table to determine a port for sending the packet to the first device in the stack of packet forwarding devices.

11. The computer program product of claim 8 wherein the vector includes a bit identifying the first device in the stack of packet forwarding devices.

12. A computer program product of claim 8 being further operable to cause a machine to:
remove the vector from the packet for delivering the packet to the exception processor shared by the packet forwarding devices in the stack.

13. The computer program product of claim 8 wherein the packet is delivered over a transmission line in an aggregate of transmission lines to the exception processor shared by the packet forwarding devices in the stack.

14. The computer program product of claim 8 wherein the vector includes bits respectively identifying the packet forwarding devices in the stack.

15. A packet forwarder comprises:
a process to insert a vector in a packet that identifies a first device in a stack of packet forwarding devices that delivers the packet to an exception processor being shared by the packet forwarding devices in the stack.

16. The packet forwarder of claim 15 further comprising:
a process to insert a flag in the packet that indicates the packet is associated with an exception.

17. The packet forwarder of claim 15 further comprising:
a process to use the vector and a table to determine a port for sending the packet to the first device in the stack of packet forwarding devices.

18. A system comprising:
a switch device capable of,
inserting a vector in a packet that identifies
a first device in a stack of packet forwarding devices that delivers the packet to an exception processor being shared by the packet forwarding devices in the stack.

19. The system of claim 18 wherein the switch device is further capable of:
inserting a flag in the packet that indicates the packet is associated with an exception.

20. The system of claim 18 wherein the switch device is further capable of:
using the vector and a table to determine a port for sending the packet to the first device in the stack of packet forwarding devices.

21. A packet forwarding device comprising:
an input port for receiving a packet;
an output port for delivering the received packet; and
a switch device capable of,
inserting a vector in a packet that identifies
a first device in a stack of packet forwarding devices that delivers the packet to an exception processor being shared by the packet forwarding devices in the stack.

22. The packet forwarding device of claim 21 wherein the switch device is further capable of:
inserting a flag in the packet that indicates the packet is associated with an exception.

23. The packet forwarding device of claim 21 wherein the switch device is further capable of:
using the vector and a table to determine a port for sending the packet to the first device in the stack of packet forwarding devices.

24. A router comprising:
a switch device capable of inserting a device vector in a packet that identifies a first device in a stack of packet forwarding devices that delivers the packet to an exception handler being shared by the packet forwarding devices in the stack.

25. The router of claim 24 wherein the switch device is further capable of inserting an exception flag in the packet that indicates the packet is associated with an exception.

26. The network switch of claim 24 wherein the switch device is further capable of using the device vector and an exception routing table to determine a port for sending the packet to the first device in the stack of packet forwarding devices.
